(19) United States
(12) Patent Application Publication
(10) Pub. No.: US 2023/0295949 A1
(43) Pub. Date: Sep. 21, 2023

(54) Collapsible Shelter

(71) Applicant: Kuat Innovations LLC, Springfield, MO (US)

(72) Inventors: Luke Kuschmeader, Springfield, MO (US); Austin Harrill, Springfield, MO (US); Robert Joslyn, Nixa, MO (US)

(73) Assignee: Kuat Innovations LLC, Springfield, MO (US)

(21) Appl. No.: 18/187,121

(22) Filed: Mar. 21, 2023

Related U.S. Application Data
(60) Provisional application No. 63/326,490, filed on Apr. 1, 2022.
(60) Provisional application No. 63/321,784, filed on Mar. 21, 2022.

(51) Int. Cl. E04H 15/06; E04H 15/48

(52) U.S. Cl. CPC E04H 15/06; E04H 15/48

(57) ABSTRACT

A collapsible shelter includes an inwardly folding hinge configured to fold into a substantially flat configuration when the collapsible shelter is closed or collapsed for transport. The hinge may be configured to fold or pull flexible shelter walls inwardly as the shelter is opened or closed. The inward folding prevents or reduces interference of the flexible shelter walls with the closing or latching of the collapsible shelter in the closed configuration. A collapsible shelter may also require multiple latches to secure it in the closed configuration during transportation on a vehicle. A collapsible shelter may also be provided with an actuator configured to release or disengage all the latches with a single operation.

### CROSS-REFERENCE TO RELATED APPLICATIONS

This application claims the benefit of (i) U.S. Provisional Pat. Application No. 63/326,490 filed on Apr. 1, 2022, and (ii) U.S. Provisional Pat. Application No. 63/321,784 filed on Mar. 21, 2022.

### BACKGROUND

### Field of the Invention

This disclosure is in the field of collapsible shelters. More specifically this disclosure is in the field of collapsible shelters such as rooftop tents for vehicles such as cars, trucks, sport utility vehicles, trailers, or other vehicles.

### Description of the Related Art

Collapsible shelters have been adopted for use on vehicles to provide convenient shelter that is easy to erect and comfortable for the user. Existing soft-sided shelters require a user to manually fold or push the side walls into the shelter as it collapses to the closed configuration. This arises from inadvertent and undesired outward folding of the soft-side shelters as the top lowers, causing the side walls to interfere with closing of the collapsible shelter and preventing the collapsible shelter from securely latching. This design typically requires a user to walk around a vehicle, and may require a user to climb onto the vehicle to access places that are difficult to reach, to tuck the shelter’s soft sides into the interior space of the closing collapsible shelter. In some instances, multiple manual operations may be required or multiple people may need to participate in closing the collapsible shelter.

Existing collapsible shelters, whether soft or hard sided, may require a user to walk around a vehicle to actuate multiple latches to secure the shelter in a closed configuration. This may be difficult or impossible for some users due to height limitations, obstructed access to the vehicle roof, or similar issues.

### SUMMARY OF THE INVENTION

In various embodiments, the inventive collapsible shelter includes an inwardly folding hinge configured to fold the side wall of the shelter inwardly as the shelter closes to a collapsed or closed configuration.

Some of the embodiments are a collapsible shelter comprising a base having a front edge, a back edge, and a first and a second side edge; a top shell having a front edge, a back edge, and a first and a second side edge; a flexible tent shell attached to the edges of the base and the top shell; a first inwardly folding hinge assembly pivotally attached to the first side edges of the base and the top shell so that it pivots inwardly; and a second inwardly folding hinge assembly pivotally attached to the second side edges of the base and the top shell so that it pivots inwardly; the inwardly folding hinge assemblies fold along a middle hinge axis from an extended configuration to a folded configuration; and the collapsible shelter folds from an open configuration with the inwardly folding hinge assemblies in an extended configuration to a closed configuration with the hinge assemblies folded inwardly between the base and the top shell.

Other embodiments of the collapsible shelter further comprise a third inwardly folding hinge assembly pivotally attached to the front edges of the base and the top shell so that it pivots inwardly. In some embodiments of the collapsible shelter the inwardly folding hinge assemblies are configured to fold a portion of the flexible tent shell between the base and the top shell in the folded configuration. In some of these embodiments the inwardly folding hinge assemblies are configured to fold three sides of the flexible tent shell between the base and the top shell in the folded configuration.

Other embodiments of the collapsible shelter comprise a base, a top shell, and a flexible tent shell attached to the base and to the top shell; and an inwardly folding hinge assembly having a lower hinge leaf and an upper hinge leaf pivotally connected at a middle hinge axis; the lower hinge leaf and the upper hinge leaf are pivotally attached to the base and the top shell respectively; and the lower hinge leaf and the upper hinge leaf fold inwardly between the base and the top shell in a closed configuration of the collapsible shelter.

In some embodiments of the collapsible shelter the lower hinge leaf is pivotally attached to the base at a lower hinge axis that is parallel to an adjacent edge of the base; and the upper hinge leaf is pivotally attached to the top shell at an upper hinge axis that is parallel to an adjacent edge of the top shell. In some embodiments of the collapsible shelter, in the closed configuration the middle axis of the hinge assembly is closer to a centerline of the base than both of the upper hinge axis and the lower hinge axis.

In some embodiments of the collapsible shelter the inwardly folding hinge assembly is disposed outside the flexible tent shell, and the inwardly folding hinge assembly is configured to draw the flexible tent shell between the base and the top shell in the closed configuration. In other embodiments of the collapsible shelter the inwardly folding hinge assembly is disposed inside the flexible tent shell, and the flexible tent shell is attached to the inwardly folding hinge assembly by at least one attachment point to draw the flexible tent shell between the base and the top shell in the closed configuration. In some of these embodiments the collapsible shelter the at least one attachment point is a sleeve in the flexible tent shell, a tie attached to the flexible tent shell, or a hook and loop strip.

In various embodiments of the collapsible shelter, folding the inwardly folding hinge assembly folds the flexible tent shell between the base and the top shell. In some of the these embodiments, unfolding the inwardly folding hinge assembly unfolds the flexible tent shell.

Other embodiments of the collapsible shelter comprise a base, a top shell, a flexible side wall attached at a lower edge to the base and at an upper edge to the top shell; and an inwardly folding hinge attached to the base and the top shell that folds from a closed configuration to an open configuration; the inwardly folding hinge folds inwardly between the base and the top shell in the closed configuration. In some of these embodiments, the inwardly folding hinge is configured to fold the flexible side wall in the closed configuration. In some embodiments the inwardly folding hinge folds the flexible side wall in the closed configuration. In some embodiments the collapsible shelter the inwardly folding hinge is configured to draw a portion of the flexible side wall between the base and the roof when the inwardly folding hinge is in the closed configuration.

In some embodiments of the collapsible shelter the inwardly folding side hinge comprises a lower leaf pivotally attached to the base; and an upper leaf pivotally attached to the top shell; the lower leaf is pivotally attached to the upper leaf on a middle hinge axis; and the lower leaf and the upper leaf fold together and pivot inwardly between the base and the top shell when the collapsible shelter is in a closed configuration. In some of these embodiments, the upper leaf and the lower leaf are nested in the closed configuration. In some of these embodiments, the upper leaf and the lower leaf each comprise two legs and a cross bar, the two legs pivotally attached to the base or top shell, and the cross bar disposed at the middle hinge axis.In varying embodiments of the collapsible shelter the flexible side wall is folded over the inwardly folding hinge in the closed configuration.

In other embodiments, the inventive collapsible shelter includes a single actuator for actuating all of the latch mechanisms used to attach the top of the shelter to the bottom of the shelter in the closed configuration. In a preferred embodiment at least two latch mechanisms are actuated by a single actuator.

### BRIEF DESCRIPTION OF THE DRAWINGS

FIG. 1A is a perspective view of an embodiment of the collapsible shelter in an open configuration.

FIG. 1B is a perspective view of the structure of an embodiment of the collapsible shelter in an open configuration with portions removed for clarity.

FIG. 1C is a perspective view of the structure of an embodiment of the collapsible shelter in a partially closed configuration with portions removed for clarity.

FIG. 1D is a perspective view of an embodiment of the collapsible shelter in a closed configuration.

FIG. 2A is an end view of an embodiment of the collapsible shelter in an open configuration.

FIG. 2B is an end view of the structure of an embodiment of the collapsible shelter in a partially open configuration.

FIG. 2C is a cross-sectional view of a portion of the structure of an embodiment of the collapsible shelter in a closed configuration.

FIG. 2D is a view of a portion of an embodiment of the collapsible shelter with the top member removed for clarity.

FIG. 2E is a detail view of a hinge in an embodiment of the collapsible shelter.

FIG. 2F is a cross-sectional view of of the structure of an embodiment of the collapsible shelter in a closed configuration with portions removed for clarity.

FIG. 3A is a top view of a portion of an embodiment of the collapsible shelter.

FIG. 3B is a top detail view of a portion of an embodiment of the collapsible shelter.

FIG. 3C is a perspective detail view of a portion of an embodiment of the collapsible shelter with some portions removed for clarity.

FIG. 3D is top detail view of a portion of an embodiment of the collapsible shelter with some portions removed for clarity.

FIG. 3E is a perspective detail view of a portion of an embodiment of the collapsible shelter.

FIG. 4A is a cut-away perspective detail view of a portion of an embodiment of the collapsible shelter in a latched configuration.

FIG. 4B is a cut-away perspective detail view of a portion of an embodiment of the collapsible shelter in an unlatched configuration.

FIG. 5A is a detail cross-sectional view of an embodiment of the collapsible shelter in a latched configuration on the axis labeled 5-5 in FIG. 4A.

FIG. 5B is a detailed cross-section view of an embodiment of the collapsible shelter in an unlatched configuration on the axis labeled 5-5 in FIG. 4A.

FIG. 6A is a cut-away perspective view of the detail area 6A in FIG. 4A.

FIG. 6B is a cut-away perspective view of the detail area 6B in FIG. 4B.

FIG. 7A is a cross-sectional perspective view of an additional embodiment of an actuator for the collapsible shelter in a latched configuration.

FIG. 7B is a cross-sectional perspective view of an additional embodiment of an actuator for the collapsible shelter in an unlatched configuration.

FIG. 8A is a cross-sectional side view of an additional embodiment of an actuator for the collapsible shelter in a latched configuration.

FIG. 8B is a cross-sectional side view of an additional embodiment of an actuator for the collapsible shelter in an unlatched configuration.

FIG. 9A is a cross-sectional top view of an additional embodiment of an actuator for the collapsible shelter in a latched configuration.

FIG. 9B is a cross-sectional top view of an additional embodiment of an actuator for the collapsible shelter in an unlatched configuration.

### DETAILED DESCRIPTION

Collapsible shelters for vehicle rooftop installation provide an option for overnight camping or similar uses with convenient transportation and rapid deployment while the shelters are installed on a vehicle. Various embodiments of the inventive collapsible shelter described herein may be used on the rooftop of a car, over the bed or cab of a pickup truck, on an overland truck rack, on a trailer, or in other similar installations. The collapsible shelters described herein provide improved functions and ease of use improvements not provided by existing collapsible shelters.

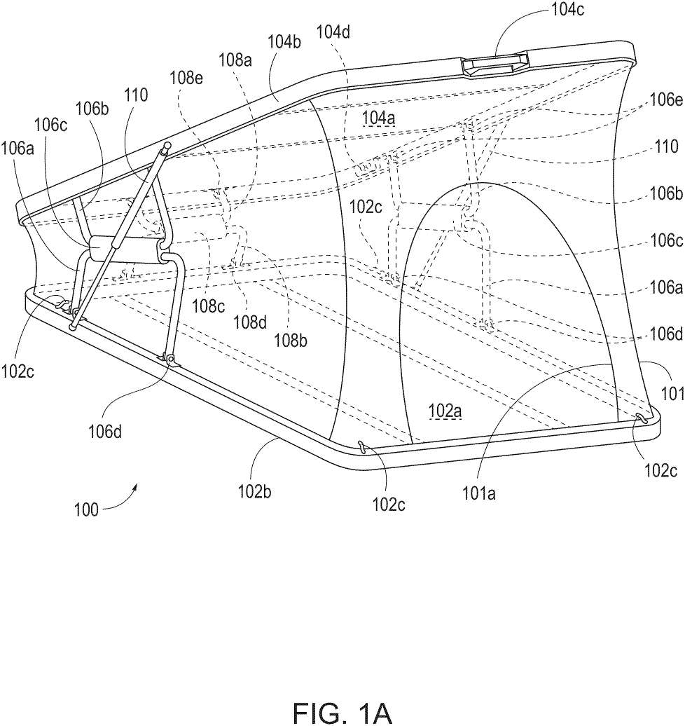

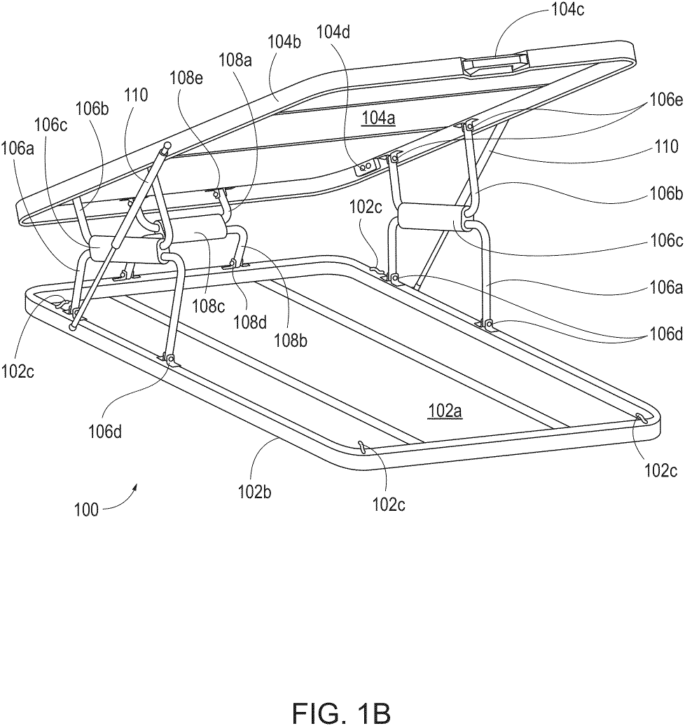

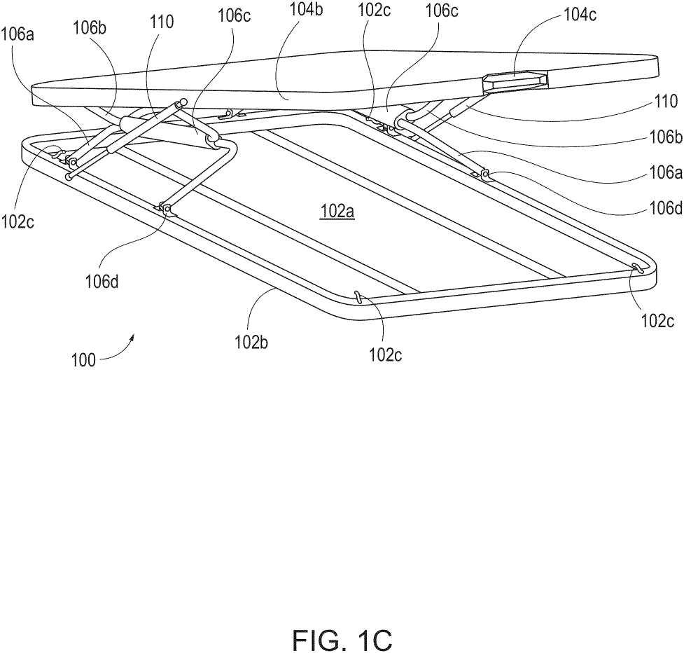

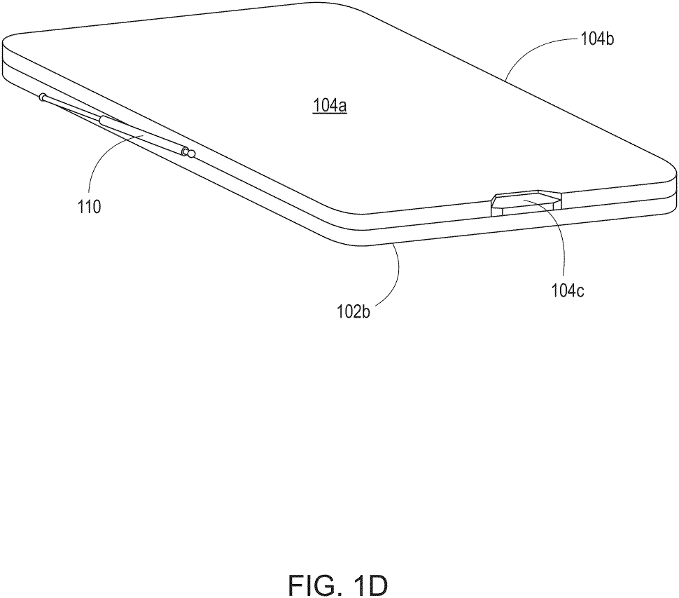

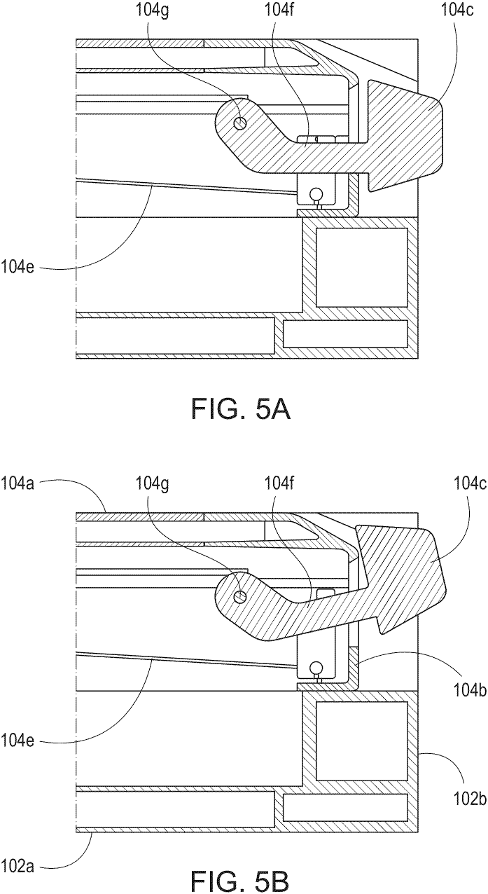

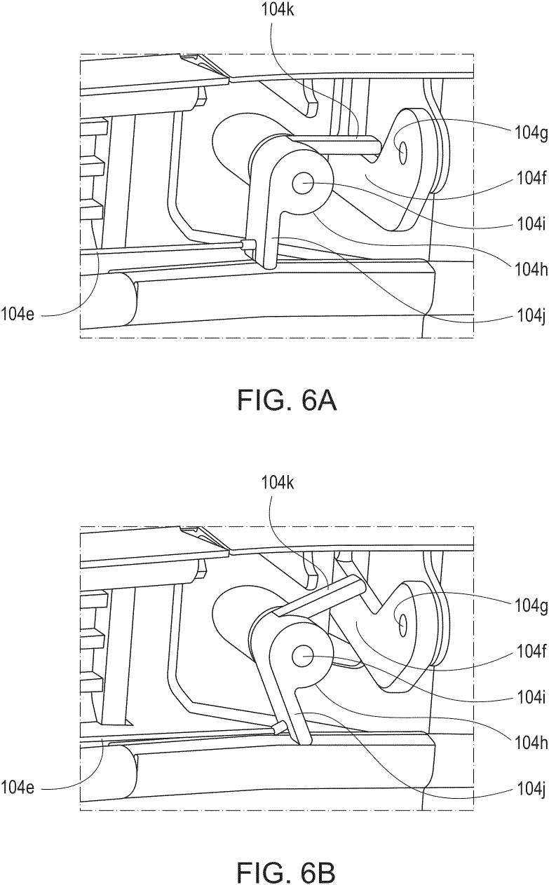

An embodiment of the inventive collapsible shelter 100 is depicted in FIGS. 1A, 1B, 1C, and 1D in open (1A and 1B), partially closed (1C), and closed (1D) configurations. The closed configuration is compatible with operation of a motor vehicle on roadways, while the open configuration allows a user to occupy the collapsible shelter when the vehicle is not in motion. The collapsible shelter may incorporate side walls made all, substantially all, or partially of fabric, flexible plastic sheets, mesh, or other soft goods suitable for a creating an enclosure suitable for providing shelter to an occupant, or combinations of the foregoing materials. The side walls of the collapsible shelter 100 have been omitted from some of the figures for clarity, including FIGS. 1B, 1C, 2D, 2E, 3A, 3B, 3C, 3D, 3E, 4A, 4B, 5A, 5B, 6A, and 6B.

In the depicted embodiments, the collapsible shelter 100 comprises a base 102 that provides the floor and bottom of the shelter 100, a top shell member 104 that is above the base 102, and a tent shell 101 that is attached to the base 102 and the top shell 104. In some embodiments top shell or top member 104 functions as a roof, or as a portion of the roof, for the collapsible shelter 100 when it is in the open configuration depicted in FIG. 1A. In many embodiments the base 102 and the top member 104 form a partially, substantially, or completely closed container when in the closed configuration depicted in FIG. 1D. In some embodiments the top shell 104 mates to the base member in the closed configuration.

The side walls 101, the base 102, and the top member 104 define an interior space for the collapsible shelter that is accessible via one or more openings or doorways 101a such as are available in tents or other types of collapsible shelters.

In some embodiments the base 102 comprises a base panel 102a provided with edges 102b. The panel 102a may comprise one or more panel of sheet metal, plastic, composite, or other similar material. More than one sheet may be joined together by ribs or joining strips to create the panel 102a. The edges 102b may be formed from extruded, cast, machined, or otherwise processed metal, or from plastic or composite materials of sufficient strength. The top or roof 104 may also comprise a top panel 104a formed from one or more panel of sheet metal, plastic, composite, or other similar material, joined together as necessary. Similarly, the edges 104b of the top 104 may be formed from extruded, cast, machined, or otherwise processed metal, or from plastic or composite materials of sufficient strength.

The base 102 and top 104 are connected by structural components and mechanisms to control, direct, and in some cases, assist, the movement of the top member 104 from the closed configuration to the open configuration in relation to the base 102. In the depicted embodiments these structural components are inwardly folding hinge assemblies 106 and 108. In various embodiments of the collapsible shelter 100, the soft side walls 101 of the collapsible shelter are disposed on an interior side of the structural components. In some embodiments the structural elements are disposed completely or partially outside of the interior volume defined by the side walls 101, top 104, and base 102. In some embodiments portions of the structural elements are disposed in contact with or connected to the side walls, such by disposition in pockets or tubes formed or provided in the side walls, or by connection thereto via brads, rivets, grommets, strips of hook and loop materials, fabric ties, or other similar fasteners. In some embodiments the side walls 101 are disposed outside of the structural members, and in those embodiments the side walls 101 may be attached to the structural members so that they are pulled inwardly with the structural members.

In some embodiments of the collapsible shelter 100, the structural elements comprise inwardly folding hinges such as side hinge assemblies 106 and end hinge assembly 108. In some embodiments of the collapsible shelter 100 the inwardly folding side hinge assemblies 106 have a lower hinge element or leaf 106a and an upper hinge element or leaf 106b. In these embodiments the lower hinge element 106a is pivotally attached to the base 102 along a lower hinge axis at or through attachment points 106d, and the upper hinge element 106b is pivotally attached to the top member 104 along an upper hinge axis at or through attachment points 106e. In the depicted embodiment the pivotal attachments 106d to the base 102 and pivotal attachments 106e to the top member 104 are disposed close to side edges of the base and top members, but in other embodiments the pivotal attachments may be spaced apart from the edges of the base 102 and top member 104.

In these and other varying embodiments the upper hinge element 106b is also pivotally attached to the lower hinge element 106a along a middle hinge axis 106c. In some embodiments the pivotal attachment along axis 106c may be formed of nested tubes that rotate with respect to each other, or a pivot axis member that allows one or both of the hinge leaves 106a and 106b to pivot with respect to the other hinge leaves 106b and 106a, respectively. Other types of pivotal connections between the hinge leaves 106a and 106b will be apparent to one of skill in the art. Similarly other embodiments of the hinges 106 and 108 may have other embodiments of the leaves 106a and 106b besides the bent tubes depicted in the figures, such as plates, composite structures, webs of material, or one or more separate pivotal arm. Other embodiments of the leaves 106a and 106b (and 108a and 108b) will be apparent to one of skill in the art.

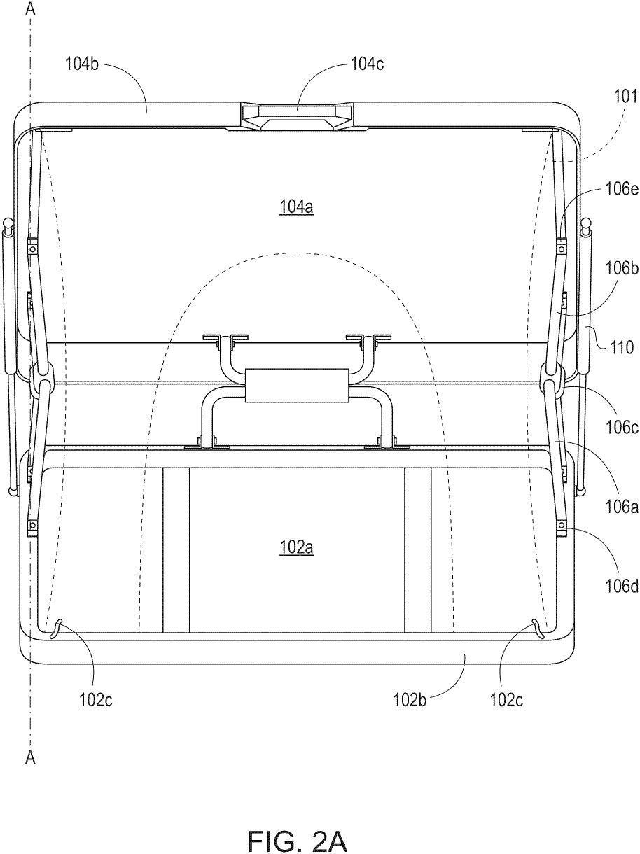

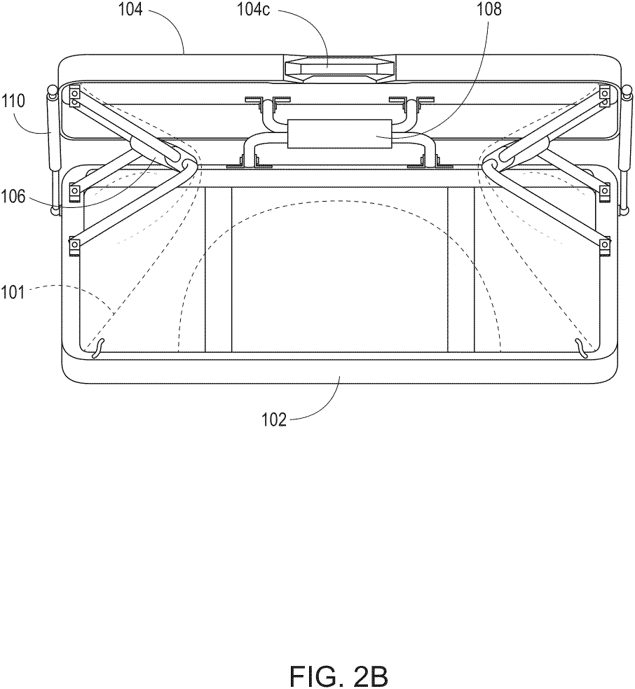

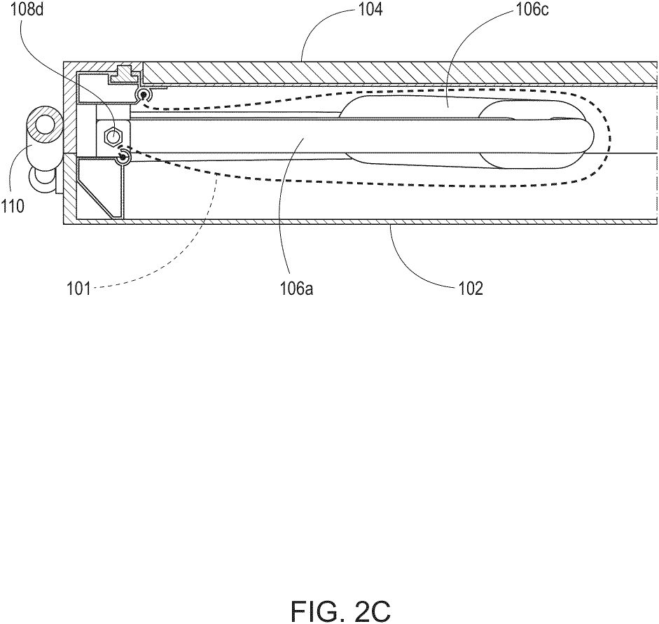

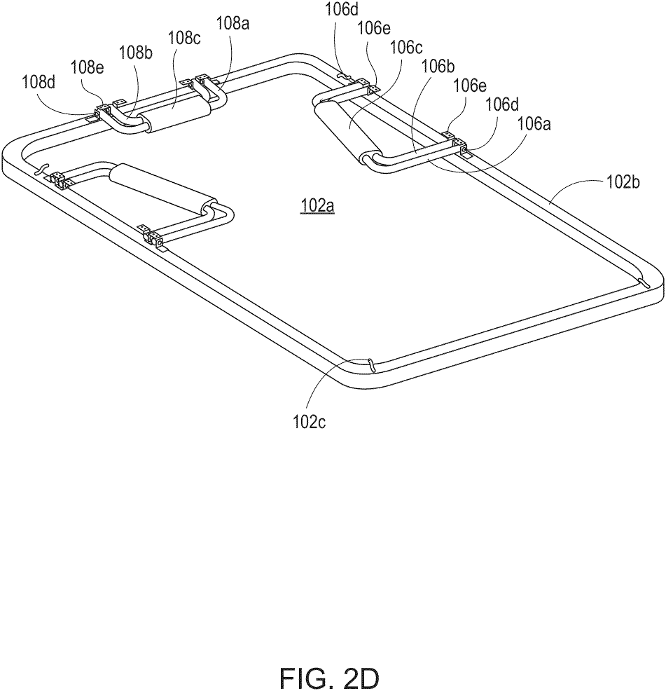

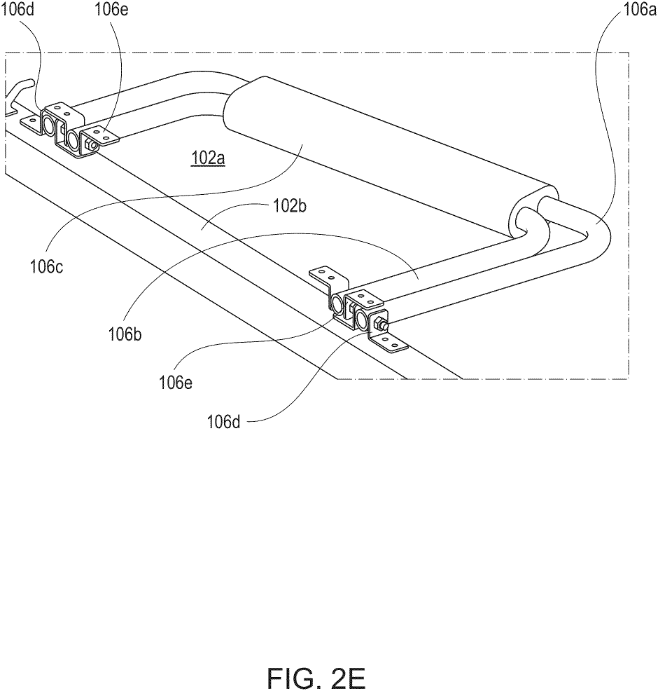

In the open configuration shown in FIGS. 1A, 1B, and 2A, the lower hinge element 106a extends approximately upwardly along its vertical dimension from the base 102 at an acute angle thereto, measured towards the interior of the collapsible shelter 100. Similarly, the upper hinge element 106b depends downwardly approximately along its vertical dimension from the top member 104 at an acute angle thereto, measured towards the interior of the collapsible shelter 100. In various embodiments, the upper acute angle is different than the lower acute angle. In some embodiments, the upper acute angle is the same as the lower acute angle. In varying embodiments, the range of the acute angles is in the range of 55 to 65 degrees, 65 to 75 degrees, 75 to 85 degrees, or 85 to 89 degrees. In preferred embodiments the acute angle is in the range of 80 to 90 degrees.

In some embodiments the hinge elements 106a and 106b are skewed or at an angle with respect to each other in the open configuration, with an obtuse angle between their approximately vertical dimensions being disposed on the side away from the interior of the collapsible shelter 100. An embodiment with the skewed members 106a and 106b is depicted in FIG. 2A. The line A-A depicts a direct line from the hinge assembly 106 attachment points at 106d and 106e. As shown in the figures, hinge assembly 106 is not in that linear axis, but is offset toward the interior of the collapsible shelter 100. In varying embodiments, the obtuse angle between the upper and lower hinge leaves 106a and 106b may be in the range of 140 to 150 degrees, 150 to 160 degrees, 160 to 170 degrees, or 170 to 179 degrees. In a preferred embodiment the obtuse angle is in the range of 170 to 180 degrees.

In some embodiments with the obtuse angle, the angle between the upper and lower hinge elements 106a and 106b may be selected to reduce or prevent buckling or inadvertent outward folding of the hinge assemblies 106 and 108 when closing the collapsible shelter 100.

In some embodiments the hinge assemblies 106 may open past the vertical line A-A depicted in FIG. 2A. The hinges may open similarly to those described above, but continue to a straight position substantially along A-A and then continue past that line to a “bent” configuration with the hinge axis 106c dispose outwardly from the line A-A. In these embodiments the relative angles between the side hinge assemblies 106 and the roof 104 and base 102 may be measured on the opposite of the hinge line and have the same values but in an outward direction away from the centerline of the collapsible shelter 100. In these embodiments the hinge assemblies 106 may be supported by pressing outwardly on the shelter walls such as fabric walls 101. Alternatively, a separate support, stop device, or other brace may hold the hinges at a desired angle.

In some embodiments an end hinge assembly 108 also provides additional support and structure to the collapsible shelter 100 at one end thereof. In a preferred embodiment the top member 104 is not parallel to the base member 102 in the open configuration. In some of these embodiments, the end hinge assembly 108 is disposed at the end having the narrower gap between the base and top members 102 and 104.

In the depicted embodiment the end hinge assembly 108 comprises a lower hinge element or leaf 108a and an upper hinge element or leaf 108b. The lower hinge element 108a and upper hinge element 108b are pivotally attached at a middle hinge axis 108c. In this embodiment lower pivotal attachments 108d at a lower hinge axis, and upper pivotal attachments 108e at an upper hinge axis, allow the hinge elements 108a and 108b to fold inwardly in a similar manner to the hinge assemblies 106. The variations of the structure of hinges 106 may also be varied in similar manners for hinge 108. Hinge assemblies 108 may have the same or different acute and obtuse angles in the open position as described with respect to the side hinge assemblies 106.

In preferred embodiments of the collapsible shelter the middle hinge axis 106c of the side hinges 106 are disposed at an angle to the planes of the base 102 and of the top member 104 in the open configuration. This allows the hinges 106 to hold the top member 104 at an angle to the base 102 in the open configuration. The angle is preferably selected so that as the hinges 106 pivot to the closed position shown in FIGS. 2C and 2D, among others, the hinges 106 are folded into a substantially flat configuration that fits between the base 102 and top member 104. This flat configuration allows the base 102 and top 104 to form a relatively thin profile to reduce wind resistance during vehicle movement, as well as providing improved product aesthetic appearance of the shelter.

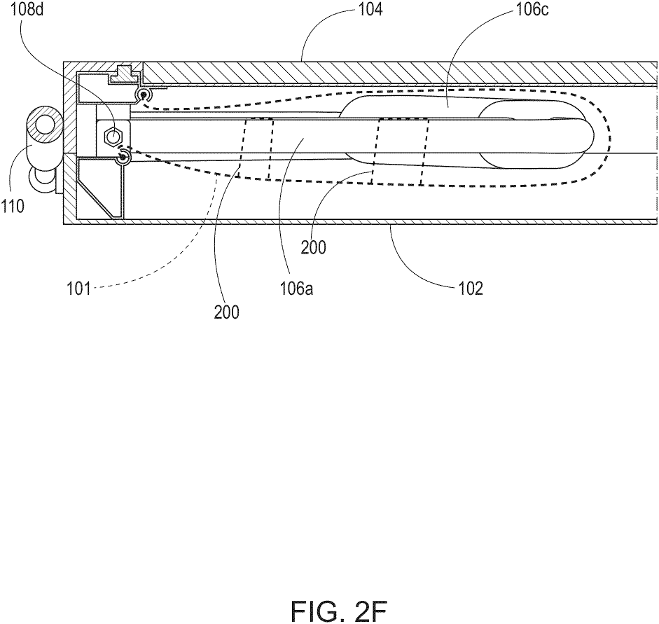

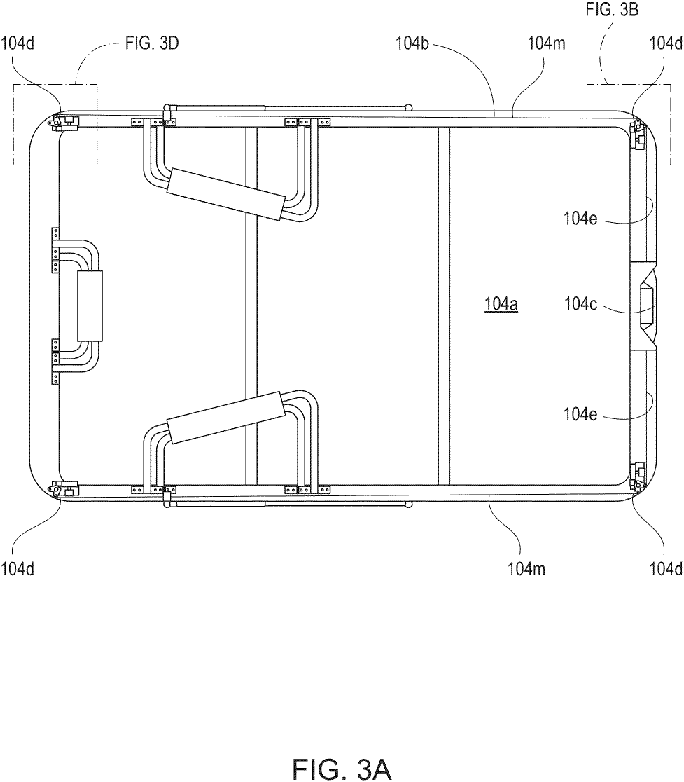

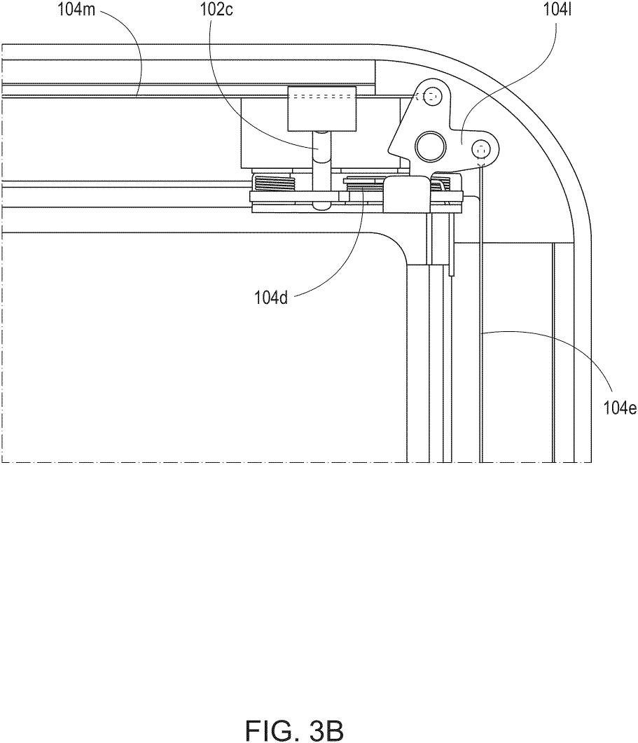

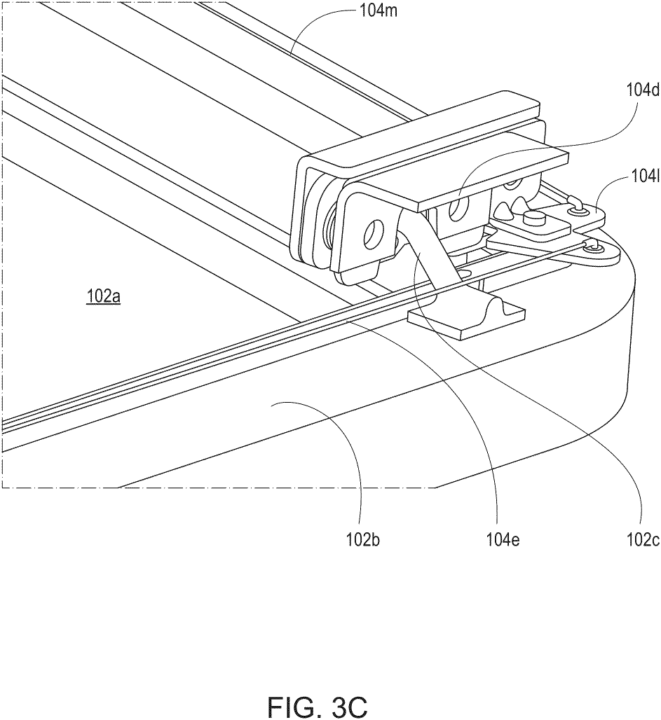

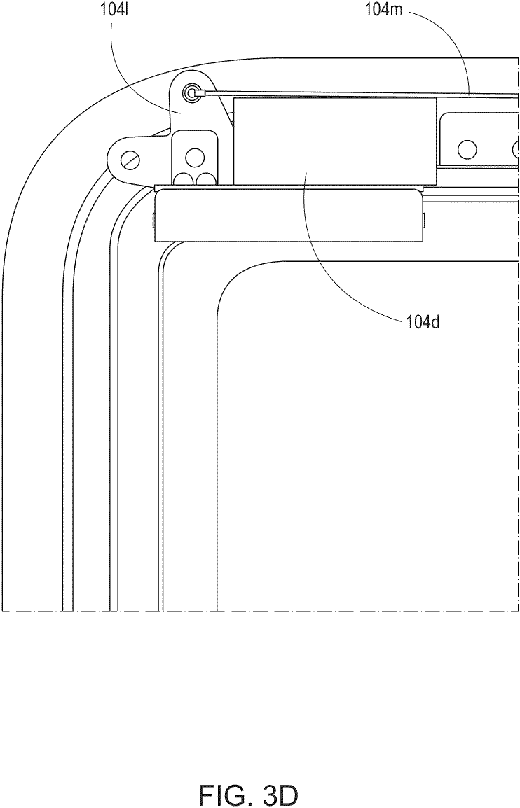

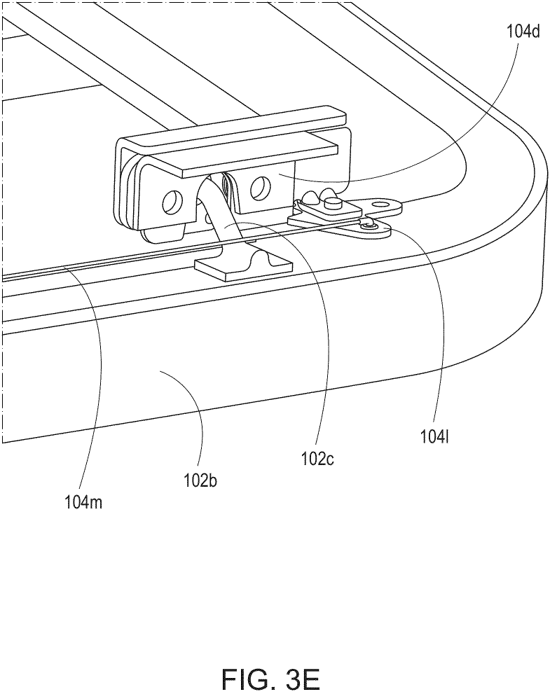

In the depicted embodiment the upper hinge assemblies 106b fit or nest within the arms of the lower hinge assembly 106a when in the closed, flat configuration, but in other embodiments the hinges may nest in another manner or overlap or sandwich together without nesting. Hinge 108 also preferably folds into a similar flat configuration as shown in FIGS. 2D and 3A for compact storage. FIGS. 2D and 2E depict an embodiment of the shelter 100 with the top 104 removed to show the folded hinge assemblies 106 and 108.

FIGS. 1C and 2B depicts an embodiment of the collapsible shelter 100 in a partially open or partially closed configuration. The hinge elements 106 and 108 are folding inwardly along middle hinge axes 106c and 108c. In some embodiments the inwardly folding hinges 106 and optional hinge 108 provide improved performance and ease of use when closing the collapsible shelter 100. In a preferred embodiment, the at least partially flexible side walls 101 of the collapsible shelter are disposed at least partially inside the hinge assemblies 106 and 108. In these and other embodiments, as the hinge assemblies 106, and optionally 108, fold inwardly they at least partially push or fold the side walls of the collapsible shelter 100 inwardly between the base 102 and the top member 104. In other embodiments the side walls 101 may be partially inside or outside the, and attached to, the structural members 106 and 108 to be pulled inwardly with the structural members. In other less-desirable, previously known collapsible shelters, as the top member closes downwardly towards the base, the flexible side walls of the collapsible shelter may fold outwardly from the base and thus require manual folding or insertion by a user to push them back in between the top and base as they close to form a container for the collapsed shelter. As shown in FIG. 2C, when in the closed position the structural members 106 and 108 of some embodiments have pulled the side walls 101 inwardly sufficient to prevent them from folding outwardly as the top 104 closes against the base 102. In the depicted embodiment the side walls 101 are wrapped or folded around the folded hinge assembly 106.

In some embodiments the improved folding characteristics of the collapsible shelter 100 allow a user to close an embodiment of the shelter 100 from one end of the shelter 100, such as by the location of a single latch element at the opposite end of the base 102 (from hinge assembly 108) for latching the top 104 to the base 102 in the closed configuration. The inward folding hinges reduce or avoid the need for the user to walk around the collapsible shelter 100 tucking the side walls 101 of the shelter 100 into the space between the base 102 and top 104 to allow complete closure. Embodiments of the collapsible shelter with or without the inwardly-folding hinge assemblies may utilize a single latch system.

In some embodiments of the collapsible shelter 100 the side walls may be partially or completely outside or on the exterior side of the hinge assemblies 106, and optionally hinge assembly 108, but attached thereto sufficiently so that as the hinge assemblies fold inwardly they will pull the side walls inwardly with them. These attachments may be loops with hook and loop areas that may be wrapped around elements of the hinge assemblies and secured in place. In other embodiments the side walls may have pockets or tubes to receive portions of the hinge assemblies 106 or 108.

Referring now to FIG. 2D, a view of an embodiment of the base 102 and hinge assemblies is depicted with the roof or top 104 removed for clarity. The side hinge assemblies 106 position the hinge axis or pivotal member 106c at an angle to the axis between the pivotal attachment points 106d and 106e which determines the angle of the roof or top 104 with respect to the base 102 when the shelter is in the open configuration. In various embodiments of the collapsible shelter the angle of the pivotal axis of 106c with respect to the pivotal axis of connections 106a may be in the range of 5-10, 10-15, 15-20, 20-25, or 30-35 degrees. In preferred embodiments the angle is approximately between 13 and 15 degrees, and in some embodiments is substantially 14 degrees. In some embodiments, when the shelter 100 is in the open configuration the angle between the top 104 and the base 102 is approximately twice the angle between the hinge axis 106c and the base 102.

In the depicted embodiment the angle of hinge pivotal member 106c is determined by the length of the legs of the upper and lower hinge elements or members 106a and 106b. For example, in the depicted embodiment, lower hinge element 106a has a long leg and a short leg.

In various embodiments the long leg may position one end the hinge pivotal member 106c a distance from 8 to 20 inches from the pivotal attachment 106d, and in a preferred embodiment the distance may be 14 inches. In various embodiments the short leg may position the other end of the hinge axis 106 a distance of 5 to 15 inches from the pivotal attachment 106d, and in a preferred embodiment the distance may be 9 inches.

The upper hinge element may also have a long leg and a short leg. In various embodiments the long leg may position one end the hinge axis 106c a distance from 6 to 18 inches from the pivotal attachment 106d, and in a preferred embodiment the distance may be 12 inches. In various embodiments the short leg may position the other end of the hinge axis 106 a distance of 4 to 12 inches from the pivotal attachment 106d, and in a preferred embodiment the distance may be 8 inches. In some cases, the dimensions of the upper and lower elements of the side hinge assemblies 106 are reversed from the embodiments described above.

In the depicted embodiments the legs of the hinge leaves 106a and 106b extend substantially perpendicularly to the edges 102b and 104b of base 102 and top 104, respectively. Other geometries for the subcomponents of the inwardly-folding hinge assemblies 106 and 108 may be utilized in other embodiments of the collapsible shelter. In some embodiments all or some portion of the legs of the hinge leaves may extend in a substantially non-perpendicular direction from the edges of the top 104 and base 102.

In varying embodiments, the end hinge assembly 108 may have a lower hinge element or member 108a that positions the hinge axis 108c a distance of between 4 and 10 inches from the pivotal attachment 108d, with a preferred embodiment having a distance of approximately 6 inches. In some embodiments, the end hinge assembly may have an upper hinge element or member 108b that positions the hinge axis 108c a distance of between 2 and 8 inches from the pivotal attachment 108e, with a preferred embodiment having a distance of approximately 5 inches. In some cases, the dimensions of the upper and lower elements of the side hinge assemblies 108 are reversed from the embodiments described above.

Referring now to FIG. 2E, a depiction of an embodiment of a hinge assembly 106 is shown in a closed position. The top and bottom members 102 and 104 have been removed from this depiction for clarity. In this embodiment the hinge leaves 106a and 106b are disposed next to each other and nested in the closed position. This provides for a thinner overall vertical dimension for the hinge assembly 106 in the closed position, allowing for a thinner overall vertical dimension for the collapsible shelter 100. A thinner overall vertical dimension is preferable for the shelter 100 for performance reasons such as aerodynamics during vehicle movement, as well as aesthetic considerations. The thinner hinge dimension may also be utilized to allow other components to be installed in the collapsible shelter, such as a thicker mattress.

Referring to FIG. 2F, a cross-section of an embodiment of the inventive collapsible shelter is depicted. In this embodiment the shelter membrane 101 is provided with sleeves 200 sewn into it for receiving parts of the hinges 106. These sleeves are similar to sleeves for a tent pole, and keep the tent membrane or other fabric 101 close to and aligned with the structure of hinge 106 when it is opening or closing. These types of attachments may be useful if the tent membrane 200 is disposed on the outside of the structure of hinge 106 to pull or draw the flexible shell 200 inwardly while the hinge is closing. As mentioned above, in other embodiments the sleeves might be replaced with other types of attachment mechanisms.

In some embodiments of the inventive collapsible shelter 100, the user may unlatch the top 104 from the base 102 using a single actuator. In some embodiments the actuator is on the external side of the shelter as depicted in the figures. In the depicted embodiment the actuator 104c is disposed at one end of the shelter 100 with the hinge assemblies 106 on the side edges of the shelter 100. In other embodiments the single latch actuator 104c may be disposed on the side edge with one of the hinge assemblies 106. FIGS. 3A, 3B, 3C, 3D, and 3E depict various components of a system for latching the shelter 100 in the closed position. FIG. 3A depicts a bottom view of an embodiment of the collapsible shelter 100 with the base unit 102 removed for clarity. FIG. 3B depicts a detailed bottom view of the area of FIG. 3A labeled 3B. FIG. 3C depicts a perspective view of the same area. FIGS. 3D and 3E depict a detailed bottom view and a detailed perspective view of the area labelled 3D in FIG. 3A.

The depicted embodiment of the collapsible shelter 100 has one latch actuator 104c and four latch mechanisms 104d. Other embodiments may have one or more latch mechanisms 104d. In a preferred embodiment of the collapsible shelter 100, a user may release all of the latch mechanisms 104d simultaneously by actuating latch actuator 104c. The latch mechanisms 104d may be actuated electrically, electronically, wirelessly, or by control wires, or of other varying types known by those of skill in the art. In the depicted embodiment the latch mechanism 104d is a type that hooks or engages a bolt 102c attached to the bottom component 104.

In the depicted embodiment of the collapsible shelter 100, control wires 104e extend from actuator 104c in opposing directions along the end edge of top unit 104. The control wires 104e connect to latch mechanisms 104d disposed near the adjacent corners of the top component 104. In this embodiment as the actuator 104c is moved by a user the control wires 104e pull the latch actuator levers 104l to release the latch mechanisms 104d.

In the depicted embodiment control wires 104m are also connected to the latch actuator levers 104l and extend the control signal to additional latch mechanisms 104d located near other corners of the top member 104. These additional latch mechanisms, depicted in this embodiment on FIG. 3D, are optional additional connections between the top member 104 and the base 102. In other embodiments of the collapsible shelter, there may be any number of latch mechanisms 104d, whether one or more, as necessary to sufficiently secure the top member 104 to the base unit 102 during transport on a vehicle operating at highway speeds or in use on an offroad vehicle traversing terrain.

The actuator 104c for releasing the latch mechanisms 104d may be manually operated by pivoting a handle, translating a slider, pushing a button (for electrical or electronic systems), or wirelessly (instead of or in addition to the prior methods). Other types of actuators may be used for actuator 104c in future embodiments of the inventive collapsible shelter. In a preferred embodiment of the collapsible shelter 100 a user will only need to actuate one latch actuator 104c to completely unlatch the top member 104 from the base 102. That may comprise releasing/disengaging one or more latch mechanisms 104d. In some embodiments the latch actuator 104c may also trigger engaging the latch mechanisms 104d or locking or unlocking the latch mechanisms 104d or have an integrated locking mechanism.

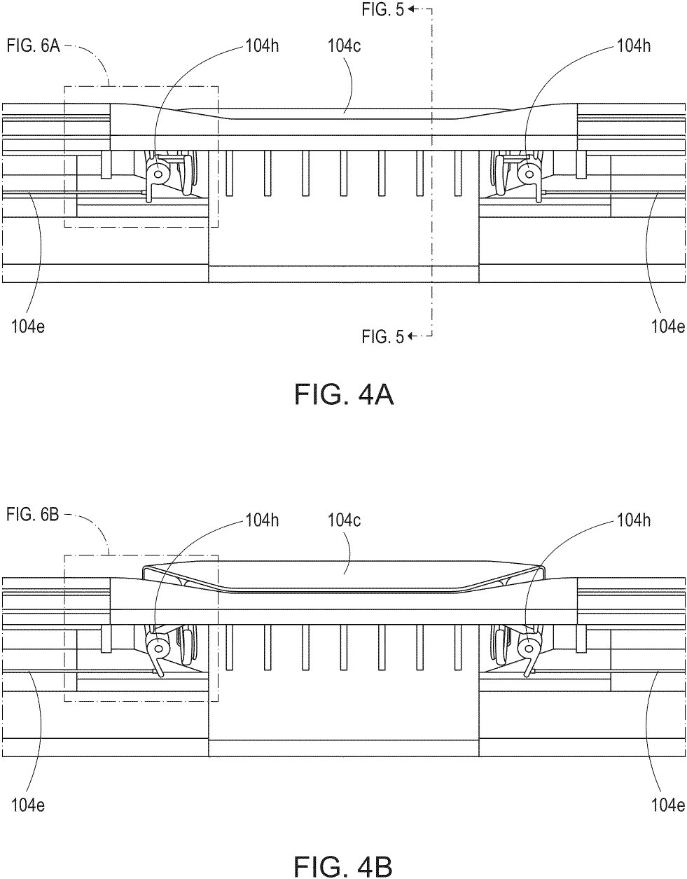

Referring to FIGS. 4A, 5A, and 6A, an embodiment of the actuator 104c for the latch system of the collapsible shelter is depicted in cutaway, cross-section, and cutaway views, respectively, in a latched or released position. FIGS. 4B, 5B, and 6B depict an embodiment of the actuator for the latch system of the collapsible shelter in cutaway, cross-section, and cutaway views, respectively, in an unlatched or actuated position. In these embodiments when a user desires to open the collapsible shelter 100, the actuator 104c is pivoted from the released position (FIGS. 4A, 5A, and 6A) to the actuated position (FIGS. 4B, 5B, and 6B). The depicted embodiment of the latch actuator 104c is connected to pivot arms 104f that pivot around pivot pins 104g. As the pivot arms 104f move upward they engage push arms 104k which in turn pivot the elbow components 104h around pivot pin 104i. The rotation of elbow component 104h causes actuator lever 104j to pull control or actuator cable 104e translating it to actuate a latch mechanism 104d.

In the depicted embodiment two elbow components 104h are disposed on opposite ends of the actuator 104c. The two elbows 104h pull the cables 104e inwardly toward the actuator 102c when it is pivoted upward by a user. In other embodiments the control wires 104e may be replaced with electrical control wires to send electrical or electronic signals to electrically actuated latch mechanisms 104d. In those embodiments the latch actuator 104c may comprise a button or other switch connected to electrical control circuitry or battery power for operating the latch mechanism 104d.

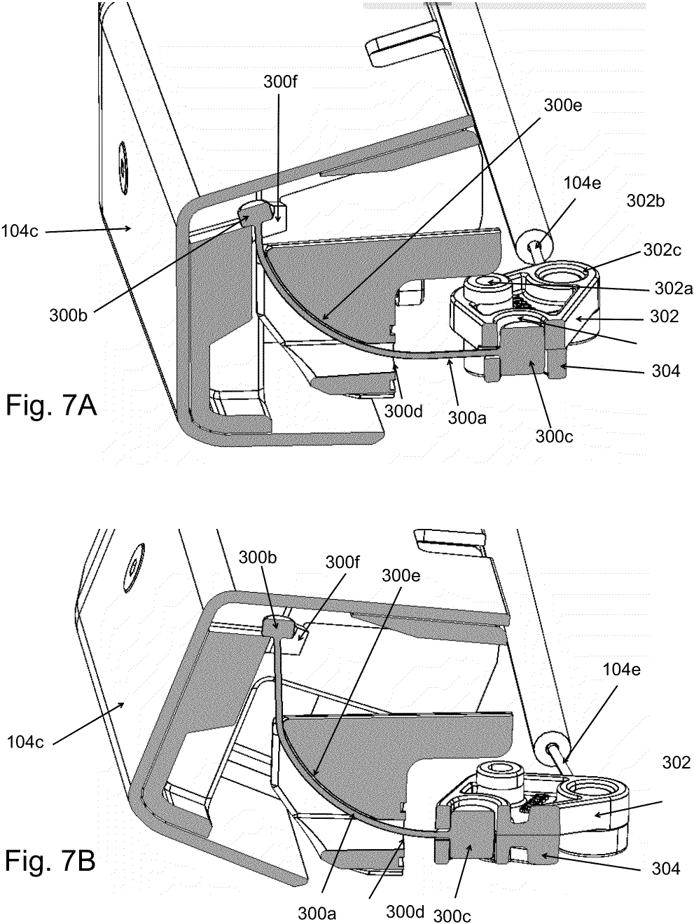

Referring to FIGS. 7A through 9B, an additional embodiment of a latch system for single actuator operation of all latches is depicted. FIGS. 7A, 8A, and 9A depict the latch actuator in a latched or closed configuration. FIGS. 7B, 8B, and 9B depict the same views but with the latch actuator in an unlatched or open configuration. In both configurations in these views the collapsible shelter is still shown with the top 104 in a closed position with respect to the bottom 102. FIGS. 7A and 7B depict cross-sectional perspective views with some components of the collapsible shelter removed for clarity.

In this embodiment of an actuator system, the actuator 104c pivots upwardly as in other disclosed embodiments. As it pivots upwardly it pulls actuator cable 300 to release the latches around the perimeter of the collapsible shelter. In the depicted embodiment actuator cable 300 comprises cable 300a, stop or barrel 300b affixed to a first end of the cable 300a, and stop or barrel 300c affixed to a second end of cable 300a. Stop or barrel 300b secures the actuator 300 to the actuator 104c, and in other embodiments may be a wire clamp or other connection instead of barrel 300b. Stop or barrel 300c applies a pulling force to the elbows 302 and 304 to transfer the movement of actuator 104c to the control wires 104e and thus to the latches at various points on the collapsible shelter. In some embodiments a wire guide 300e may be provided as part of the lower edge 102b to prevent kinking, bending, or misfeeding of the cable 300a. In the depicted embodiment wire guide 300e comprises an arcuate groove leading from aperture 300d to the connection to actuator 104, in this case at flange 300f.

Actuator cable 300 extends through an aperture 300d into the interior of the collapsible shelter. This embodiment requires only a single aperture into the collapsible shelter’s interior thus reducing water intrusion. An o-ring or other seal may be provided at the aperture 300d to further reduce water intrusion.

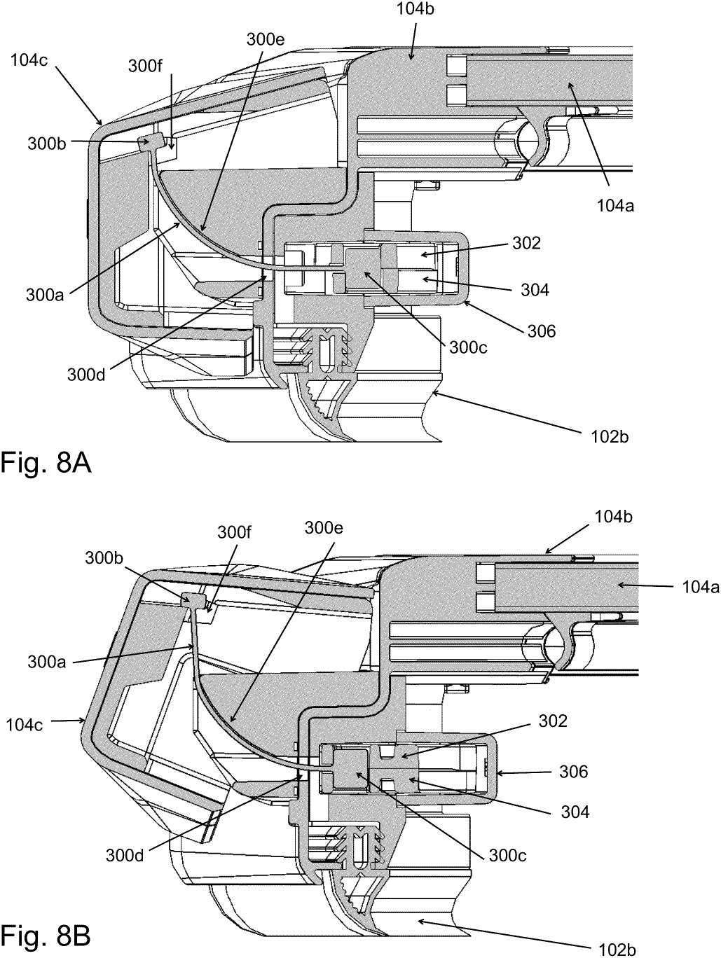

As can be seen by comparing FIG. 7A with FIG. 7B, and FIG. 8A with FIG. 8B, when the actuator 104c is moved to the unlatched position, cable 300a slides in groove 300e, and barrel 300c is translated closer to aperture 300d (which is part of base edge 102b) thus pulling on and rotating the elbows 302 and 304 as described below. The elbows may be pivotally mounted on a housing 306 provided on base 102.

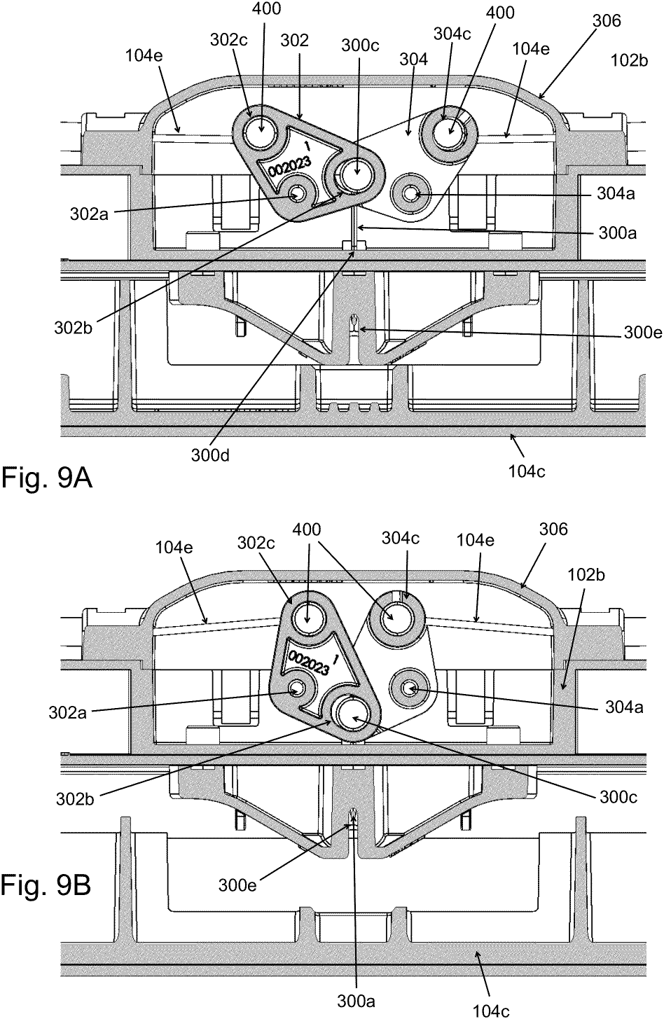

As can be seen most clearly in FIGS. 9A and 9B, in this embodiment of the actuator system the translation of wire 300a and barrel 300c pivots elbows 302 and 304. In this embodiment the elbows 302 and 304 are pivotally mounted on base 102 or base edge 102b at axes 302a and 304a respectively. In some embodiments there may only be one elbow, or the elbows may be spaced apart. In this embodiment one elbow 302 is mounted slightly above elbow 304 so that they overlap (when viewed from above) at apertures or sockets 302b and 304b so that both elbows may engage a single barrel 300c attached to the end of cable 300a.

In this embodiment translation of barrel 300c causes elbows 302 and 304 to pivot around pins or axes 302a and 304a, respectively. The pivotal movement of elbows 302 and 304 causes apertures or sockets 302c and 304c to move in arcuate paths. Control wires 104e are attached to barrels or stops 400 which are disposed in apertures or sockets 302c and 304c. Thus, the movement of those apertures is transferred to control wires 104e and on to the latches disposed around the collapsible shelter.

The following item lists A, B, and C are illustrative, but not limiting, of embodiments of the inventive collapsible shelter. Features of the following item lists may constitute features of the other item lists. The reference numbers provided in the item descriptions are for ease of reference to the figures and shall not be construed as limiting their subject matter.

A1. A collapsible shelter having a base member (102), a top shell (104), a flexible membrane (101) attached to the base member (102) and the top shell (104), and an inwardly folding hinge (106) attached to the base member (102) and the top shell (104).

A2. The collapsible shelter according to item A1, wherein the flexible membrane (101) is partially rigid.

A3. The collapsible shelter according to any of the preceding A items, wherein the inwardly folding hinge (106) folds the flexible membrane (101) between the base member (102) and the top shell (104).

A4. The collapsible shelter according to any of the preceding A items, wherein the inwardly folding hinge (106) draws the flexible membrane (101) between the base member (102) and the top shell (104).

A5. The collapsible shelter according to any of the preceding A items, wherein a portion of the flexible membrane is automatically folded between the base member (102) and the top shell (104) by the inwardly folding hinges (106).

A6. The collapsible shelter according to any of the preceding A items, wherein the inwardly folding hinges (106) comprise an upper leaf and a lower leaf.

A7. The collapsible shelter according to any of the preceding A items, wherein the upper leaf nests with the lower leaf in a closed configuration.

A8. The collapsible shelter according to any of the preceding A items, wherein the inwardly folding hinge (106) is configured to pull the flexible membrane (101) outwardly in the open configuration.

A9. The collapsible shelter according to any of the preceding A items, wherein the inwardly folding hinge (106) is configured to push the flexible membrane (101) outwardly in the open configuration.

A10. The collapsible shelter according to any of the preceding A items, wherein the flexible membrane (101) is attached to the inwardly folding hinge (106).

A11. The collapsible shelter according to any of the preceding A items, wherein the flexible membrane (101) is attached to the inwardly folding hinge (106) by a sleeve, a strap, a tie, a rivet, a brad, a hook and loop material, or a elastic cord.

B1. A collapsible shelter comprising a base member (102), a top member (104) configured to latch to the base member (102), and a single actuator (104c) configured to unlatch the top member (104) from the base member (102).

B2. The collapsible shelter according to item B1 where the single actuator (104c) is attached to an external surface of the shelter.

B3. The collapsible shelter according to any of the preceding B items, where the single actuator (104c) is disposed on the top member (104).

B4. The collapsible shelter according to any of the preceding B items, where the single actuator (104c) is disposed on the base member (102).

B5. The collapsible shelter according to any of the preceding B items, where the single actuator (104c) is disposed on a rear edge of the top member (104).

B6. The collapsible shelter according to any of the preceding B items, further comprising at least one latch (104d) configured to latch the top member (104) to the base member (102) in a closed configuration.

B7. The collapsible shelter according to any of the preceding B items, wherein the actuator (104c) is wirelessly activated.

B8. The collapsible shelter according to any of the preceding B items, wherein the actuator is disposed inside the collapsible shelter when the top member (104) is in the closed configuration.

B9. The collapsible shelter according to any of the preceding B items, comprising a plurality of latches (104d) configured to secure the top member (104) in a closed configuration.

B10. The collapsible shelter according to item B9, where the plurality of latches are spaced apart around the perimeter of the base member (102).

B11. The collapsible shelter according to any of the preceding B items, wherein the actuator (104c) is pivotally attached to the top member (104) or the base member (102).

B12. The collapsible shelter according to any of the preceding B items, wherein the actuator (104c) is configured to pivot upward to release the latches securing the top member (104) to the base member (102).

B13. The collapsible shelter according to any of the preceding B items, further comprising an actuator elbow (104h).

B14. The collapsible shelter according to any of the preceding B items, further comprising a control wire (104e) connected to the elbow for releasing at least one of the latches (104d).

B15. The collapsible shelter according to any of the preceding B items, wherein pivotal movement of the actuator (104c) pivots the elbow (104h).

B16. The collapsible shelter according to any of the preceding B items, wherein pivotal movement of the elbow (104h) translates the control wire (104e).

B17. The collapsible shelter according to any of the preceding B items, wherein translation of the control wire (104e) releases at least one latch.

B18. The collapsible shelter according to any of the preceding B items, wherein movement of the actuator (104c) simultaneously releases all latches (104d) securing the top member (104) to the base unit (102).

B19. The collapsible shelter according to any of the preceding B items, wherein the base member (102) is substantially rectangular in top aspect and a latch is disposed near or adjacent to each corner thereof.

B20. The collapsible shelter according to any of the preceding B items, wherein the actuator pushes an arm extending from the elbow (104h) to pivot it upon actuation.

B21. The collapsible shelter according to any of the preceding B items, wherein the latches (104d) are wirelessly released by the actuator (104c).

C1. A collapsible shelter comprising a base unit (102), a top shell (104), a plurality of latches (104d) configured to secure the top shell (104) to the base unit (102), and an actuator (104c) configured to release all of the plurality of latches (104d).

C2. The collapsible shelter according to any of the preceding C items, wherein the actuator (104c) simultaneously releases all of the plurality of latches (104d).

C3. The collapsible shelter according to any of the preceding C items, wherein the actuator (104c) is configured to simultaneously releases all of the plurality of latches (104d).

C4. The collapsible shelter according to any of the preceding C items, wherein the actuator (104c) is disposed on a rear edge of the top shell (104).

C5. The collapsible shelter according to any of the preceding C items, wherein the top shell (104) may be moved to an open configuration when the latches (104d) are released by the actuator (104c).

C6. The collapsible shelter according to any of the preceding C items, wherein the latches (104d) are configured to latch automatically when the top shell (104) is moved to the closed configuration.

In various contexts, the words “interior” or “inside” refer to the volume enclosed by the collapsible shelter or the volume between the top and bottom members. Similarly, in various contexts, the words “exterior” or “outside” refer to positions not in the volume enclosed by the collapsible shelter or the volume between the top and bottom members. Relative descriptions such as an “inside surface” refer to the aspect closer to the interior volume of the collapsible shelter, while “outside surface” refer to the aspect farther away from the interior volume thereof. Similarly, directionally descriptions like “inwardly” correspond to motion generally toward the interior or inside surfaces, while “outwardly” corresponds to motion generally toward the exterior or outside surfaces.

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices, and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A collapsible shelter comprising:
a base having a front edge, a back edge, and a first and a second side edge;
a top shell having a front edge, a back edge, and a first and a second side edge;
a flexible tent shell attached to the edges of the base and the top shell;
a first inwardly folding hinge assembly pivotally attached to the first side edges of the base and the top shell so that it pivots inwardly; and
a second inwardly folding hinge assembly pivotally attached to the second side edges of the base and the top shell so that it pivots inwardly;
wherein the inwardly folding hinge assemblies fold along a middle hinge axis from an extended configuration to a folded configuration; and
wherein the collapsible shelter folds from an open configuration with the inwardly folding hinge assemblies in an extended configuration to a closed configuration with the hinge assemblies folded inwardly between the base and the top shell.

2. The collapsible shelter of claim 1 further comprising a third inwardly folding hinge assembly pivotally attached to the front edges of the base and the top shell so that it pivots inwardly.

3. The collapsible shelter of claim 1 wherein the inwardly folding hinge assemblies are configured to fold a portion of the flexible tent shell between the base and the top shell in the folded configuration.

4. The collapsible shelter of claim 2 wherein the inwardly folding hinge assemblies are configured to fold three sides of the flexible tent shell between the base and the top shell in the folded configuration.

5. A collapsible shelter comprising:
a base, a top shell, and a flexible tent shell attached to the base and to the top shell; and
an inwardly folding hinge assembly having a lower hinge leaf and an upper hinge leaf pivotally connected at a middle hinge axis;
wherein the lower hinge leaf and the upper hinge leaf are pivotally attached to the base and the top shell respectively; and
wherein the lower hinge leaf and the upper hinge leaf fold inwardly between the base and the top shell in a closed configuration of the collapsible shelter.

6. The collapsible shelter of claim 5 wherein the lower hinge leaf is pivotally attached to the base at a lower hinge axis that is parallel to an adjacent edge of the base; and
wherein the upper hinge leaf is pivotally attached to the top shell at an upper hinge axis that is parallel to an adjacent edge of the top shell.

7. The collapsible shelter of claim 6 wherein in the closed configuration the middle axis of the hinge assembly is closer to a centerline of the base than both of the upper hinge axis and the lower hinge axis.

8. The collapsible shelter of claim 5 wherein the inwardly folding hinge assembly is disposed outside the flexible tent shell, and the inwardly folding hinge assembly is configured to draw the flexible tent shell between the base and the top shell in the closed configuration.

9. The collapsible shelter of claim 5 wherein the inwardly folding hinge assembly is disposed inside the flexible tent shell, and the flexible tent shell is attached to the inwardly folding hinge assembly by at least one attachment point to draw the flexible tent shell between the base and the top shell in the closed configuration.

10. The collapsible shelter of claim 9 wherein the at least one attachment point is a sleeve in the flexible tent shell, a tie attached to the flexible tent shell, or a hook and loop strip.

11. The collapsible shelter of claim 5 wherein folding of the inwardly folding hinge assembly folds the flexible tent shell between the base and the top shell.

12. The collapsible shelter of claim 11 wherein unfolding of the inwardly folding hinge assembly unfolds the flexible tent shell.

13. A collapsible shelter comprising:
a base, a top shell, a flexible side wall attached at a lower edge to the base and at an upper edge to the top shell; and
an inwardly folding hinge attached to the base and the top shell that folds from a closed configuration to an open configuration;
wherein the inwardly folding hinge folds inwardly between the base and the top shell in the closed configuration.

14. The collapsible shelter of claim 13 wherein the inwardly folding hinge is configured to fold the flexible side wall in the closed configuration.

15. The collapsible shelter of claim 13 wherein the inwardly folding hinge folds the flexible side wall in the closed configuration.

16. The collapsible shelter of claim 13 wherein the inwardly folding hinge is configured to draw a portion of the flexible side wall between the base and the roof when the inwardly folding hinge is in the closed configuration.

17. The collapsible shelter of claim 13 wherein the inwardly folding side hinge comprises:
a lower leaf pivotally attached to the base; and
an upper leaf pivotally attached to the top shell;
wherein the lower leaf is pivotally attached to the upper leaf on a middle hinge axis; and
wherein the lower leaf and the upper leaf fold together and pivot inwardly between the base and the top shell when the collapsible shelter is in a closed configuration.

18. The collapsible shelter of claim 17 wherein the upper leaf and the lower leaf are nested in the closed configuration.

19. The collapsible shelter of claim 17 wherein the upper leaf and the lower leaf each comprise two legs and a cross bar, the two legs pivotally attached to the base or top shell, and the cross bar disposed at the middle hinge axis.

20. The collapsible shelter of claim 17 wherein the flexible side wall is folded over the inwardly folding hinge in the closed configuration.
